(19) United States
(12) Patent Application Publication
(10) Pub. No.: US 2022/0284028 A1
(43) Pub. Date: Sep. 8, 2022

(54) TRANSFORMER FOR ENCODING TEXT FOR USE IN RANKING ONLINE JOB POSTINGS

(71) Applicant: Microsoft Technology Licensing, LLC, Redmond, WA (US)

(72) Inventors: Meng Meng, San Jose, CA (US); Daniel Sairom Krishnan Hewlett, Sunnyvale, CA (US); Sriram Vasudevan, Mountain View, CA (US)

(21) Appl. No.: 17/195,261

(22) Filed: Mar. 8, 2021

(51) Int. Cl. G06F 16/2457; G06Q 10/10; G06N 3/08

(52) U.S. Cl. CPC G06F 16/24578; G06Q 10/105; G06N 3/08

(57) ABSTRACT

Described herein is machine learning model comprising a neural network that is trained to generate a ranking score for an online job posting. The neural network takes as input a variety of input features, including at least a first input feature that is an encoded representation of a search query as generated by a first Transformer encoder, an encoded representation of a job title as generated by a second Transformer encoder, and an encoded representation of a company name as generated by a third Transformer encoder. Once a plurality of online job postings are ranked, some subset of the plurality are presented in a user interface, ordered based on their respective ranking scores.

### TECHNICAL FIELD

The present application generally relates to a machine learning technique that involves the use of a type of neural network referred to as a Transformer for encoding sequences of text to generate encoded representations of the texts that are then used as inputs to a deep neural network configured to generate a ranking score for an online job posting.

### BACKGROUND

Many search systems utilize algorithms that involve two steps. First, a user-specified search query is received and processed to identify a set of candidate search results. Next, various attributes of the search results, information relating to the end-user who provided the search query, and the query itself are used as inputs to a ranking system to rank the various search results so that those deemed most relevant can be presented most prominently. Accordingly, the text of the search query and text associated with the search results play an important role in ensuring that relevant search results are identified and appropriately ranked for presentation to the end-user. For example, consider an online job hosting service that provides employers with the ability to post online job postings, while offering jobseekers a search capability that allows for specifying a text-based query to search for relevant job postings. The text that is entered by a jobseeker for use as a search query reveals the jobseeker's intent, while the text of the job title and the text of the company name provide important and relevant information about the relevance of any individual job posting. Many conventional search engines rely exclusively on simple text-based matching algorithms to process jobseeker search queries and in ranking online job postings. However, these text-based matching systems frequently fail to efficiently and accurately capture the true intent of the jobseeker. By way of example, if a jobseeker specifies a search query consisting of the text, “software engineer,” a text-based matching algorithm may fail to accurately identify and rank relevant job postings that use alternative language, such as “computer programmer” or “application developer,” despite the fact that such job postings may be relevant and of interest to the jobseeker. With many types of ranking systems, the use of input features that are derived from text can significantly contribute to the success of a machine learned ranking model.

### BRIEF DESCRIPTION OF THE DRAWINGS

Embodiments of the present invention are illustrated by way of example and not limitation in the figures of the accompanying drawings, in which:

FIG. 1 is a user interface diagram illustrating a user interface in which search results are presented in response to a search of online job postings, which have been ranked in accordance with an embodiment of the present invention:

FIG. 2 is a diagram showing the functional components of an online service having a job search engine with which an embodiment of the invention might be implemented:

FIG. 3 is a diagram illustrating a technique by which a machine learned model is trained to rank online job postings, consistent with some embodiments of the present invention;

FIG. 4 is a diagram illustrating a Transformer encoder—a type of deep learning model—that is used to encode various sequences of text (e.g., a search query, a job title, a company name) for use as inputs to a deep neural network that is used to rank search results (e.g., online job postings) consistent with embodiments of the invention:

FIG. 5 is a diagram illustrating a bar chart showing the distribution of the lengths of job titles used in online job postings over a prior period of time, which may be used in selecting an input length threshold for the text sequence length of job titles used as inputs to a Transformer encoder, consistent with some embodiments;

FIG. 6 is a diagram illustrating a machine learned model as used to rank search results (e.g., online job postings), consistent with embodiments of the invention:

FIG. 7 is a flow diagram illustrating a method for processing a search query, consistent with embodiments of the invention:

FIG. 8 is a diagram illustrating a software architecture, in accordance with an example embodiment; and

FIG. 9 illustrates a diagrammatic representation of a machine in the form of a computer system within which a set of instructions may be executed for causing the machine to perform any one or more of the methodologies discussed herein, consistent with embodiments of the present invention.

### DETAILED DESCRIPTION

Described herein are methods and systems for using a type of neural network referred to as a Transformer encoder to encode sequences of text for use as input features to a deep neural network that has been configured to output a ranking score for an online job posting. Specifically, the present disclosure describes techniques for generating an encoded representation of a sequence of words—for example, such as a user-specified search query. The encoded representation of the words is then used as an input feature to a deep neural network which, based on a variety of input features in addition to the encoded representation of the search query, outputs a ranking score for an online job posting. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

A variety of natural language processing techniques that use deep learning models have been used to learn the meaning of their text inputs. Generally, such techniques involve vector space models that represent words using low dimensional vectors called embeddings. To apply vector space models to sequences of words, it is necessary to first select an appropriate composition function, which is a mathematical process for combining multiple words into a single vector. Composition functions come in two classes. Some composition functions are referred to as unordered functions, as the input texts are treated as a bag of word embeddings without consideration of their order. A second type of composition function may be referred to as a syntactic or semantic composition function, which takes into account word order and sentence structure. Sequence modeling techniques are examples of syntactic composition functions. While both techniques have proven effective, syntactic composition functions have been shown to outperform unordered composition functions in a variety of tasks.

However, syntactic composition functions tend to be more complex than their unordered counterparts, requiring significantly more training time. Furthermore, syntactic composition functions are prohibitively expensive in the case of huge datasets, situations in which computing resources are limited, and in online serving where the latency associated with inference time is a driving factor. Many of the best performing syntactic composition functions are based on complex recurrent neural networks or convolutional neural networks. Due to the sequential nature in which these neural networks process their inputs, these types of neural networks do not allow for parallelization during training, and thus require significant computational resources to operate effectively.

A relatively new type of deep learning model referred to as a Transformer has been designed to handle sequential data (e.g., sequences of text), while allowing for parallel processing of the sequential data. For instance, if the input data is a sequence of words, the Transformer does not need to process the beginning of the sequence prior to processing the end of the sequence, as is the case with other types of neural networks. As a result, with Transformers, the parallelization of computational operations results in reduced training times and significant efficiency improvements with larger datasets. Like other neural networks, Transformers are frequently implemented with multiple layers, such that the computational complexity per layer is a function of the length of the input sequence and the dimension of the vector representation of the input tokens (e.g., the word embeddings). The table immediately below provides a per-layer comparison of some key metrics, for layers of different model types, including a Transformer, Recurrent Neural Network and a Convolutional Neural Network. These key metrics are expressed in terms of the length of the input sequence (“n”), the dimension of the vector representation of each input token (“d”), and the size of the kernel matrix used in convolutional operations at each layer of a convolutional network (“k”). The first metric is the total computational complexity per layer. The second metric relates to the amount of computation that can be parallelized, as measured by the minimum number of sequential operations required by each layer type. Finally, the third metric is the maximum path length between long range dependencies in the network. One of the key factors impacting the ability to learn such dependencies is the length of the paths forward and backward signals have to traverse in the network. The shorter the path, the easier it is to learn long-range dependencies. Thus, the maximum path length represents the length between any two input and output positions in networks composed of the different layers.

| | Complexity | Sequential | Maximum |
|---|---|---|---|
| Layer Type | per Layer | Operations | Path Length |
| Transformer | O(n² * d) | O(1) | O(1) |
| Recurrent | O(n * d²) | O(n) | O(n) |
| Convolutional | O(k * n * d²) | O(1) | O(logₖ(n)) |

As is evident from the table, Transformers provide advantages over other network types in as much as the number of sequential operations and maximum path length per layer is a constant at one per layer. This being the result of the Transformer's ability, at each layer, to receive and process a sequence of text in parallel. Nonetheless, the computational complexity per layer is a function of the length of the input sequence (“n”) and dimension (“d”) of the vector representation. Consequently, implementing a Transformer in an online context where the latency associated with inference time is a primary concern remains a challenge. In particular, using Transformers in an online service context when latency is a driving factor, such as ranking search results, is problematic, particularly when the sequences of input text are lengthy.

Consistent with embodiments of the present invention, Transformer encoders are used to encode text as part of a machine learned model where a learning to rank approach is taken for ranking online job postings. The Transformers encode certain sequences of input text, and the encoded representations are provided to a deep neural network as input features, which, in combination with a variety of other input features, are used by the deep neural network to generate a ranking score for an online job posting. Consistent with some embodiments, the sequences of text that are encoded by the Transformers include the user-specified search query, the job title of a job posting, and the company name associated with a job posting. In other embodiments, other types of text might also be encoded with Transformers.

Consistent with embodiments of the present invention, an end-user specified search query is first received at a search engine of an online service. The search query is processed to identify an initial set of candidate job postings that satisfy the search query. For example, a search-based matching algorithm may use terms of the user-specified search query, individually and/or in combination, to identify job postings that include the same or similar terms. The result of processing the search query is a set of candidate job postings. Then, a machine learned model is used to generate a ranking score for each job posting in the set of candidate job postings. During the ranking stage, when the model is generating a ranking score for a particular job posting, Transformer encoders are used to encode sequences of text that correspond with the end-user specified search query, the job title of the particular job posting, and the company name of the company associated with the particular job posting. Finally, after a ranking score has been derived for all of the candidate job postings, a subset of the highest-ranking candidate job postings is selected for presentation to the end-user in a search results user interface.

Consistent with some embodiments, to reduce the overall complexity in implementing the Transformer encoders and to ensure latency requirements are satisfied with respect to the inference time, a maximum sequence length of each type of input—for example, search query, job title, and company name—is first determined by performing offline analysis. For example, with respect to search queries, a distribution of the frequency of the length of historical search queries processed by the online service may be analyzed to establish a maximum text input sequence length (e.g., an input length threshold) that will ensure coverage for some high percentage of search queries. For instance, the input length threshold for search queries may be selected to ensure that some high percentage, or range of percentages (e.g., 95%, or 90-98%) of all historical search queries processed over some prior duration of time would fall within the limit—that is, would have sequence lengths that do not exceed the input length threshold. This same analysis is done for all text input types, including search queries, job titles, and company names. Accordingly, the input length threshold for each text input type may vary by input type. Consistent with some embodiments, based on the offline analyses, the input length threshold for the length of a search query may be set to a value (e.g., eight words) that falls within a range of values, such as six to ten words. Similarly, the input length threshold for a job title may be selected to fall within the range of twelve to eighteen words, while the input length threshold for a company name may be selected to fall within the range of eight to twelve words.

In addition to reducing the computational complexity, and thus latency, of the Transformers by establishing a maximum text input length for each type of text input to be encoded by a Transformer, various hyperparameters of the Transformer are selected to ensure optimal performance of the overall ranking system. For example, with some embodiments, each Transformer used for encoding each text input type is configured to operate with a single layer having a fixed number of attention heads (e.g., ten) and feed forward mechanisms. By using the Transformers to encode the search query, job title, and company name, the overall ranking of the job postings is advantageously improved, providing an overall better experience for the job-seeking end-user. Various other advantages of embodiments of the invention will be readily apparent from the description of the figures that follows.

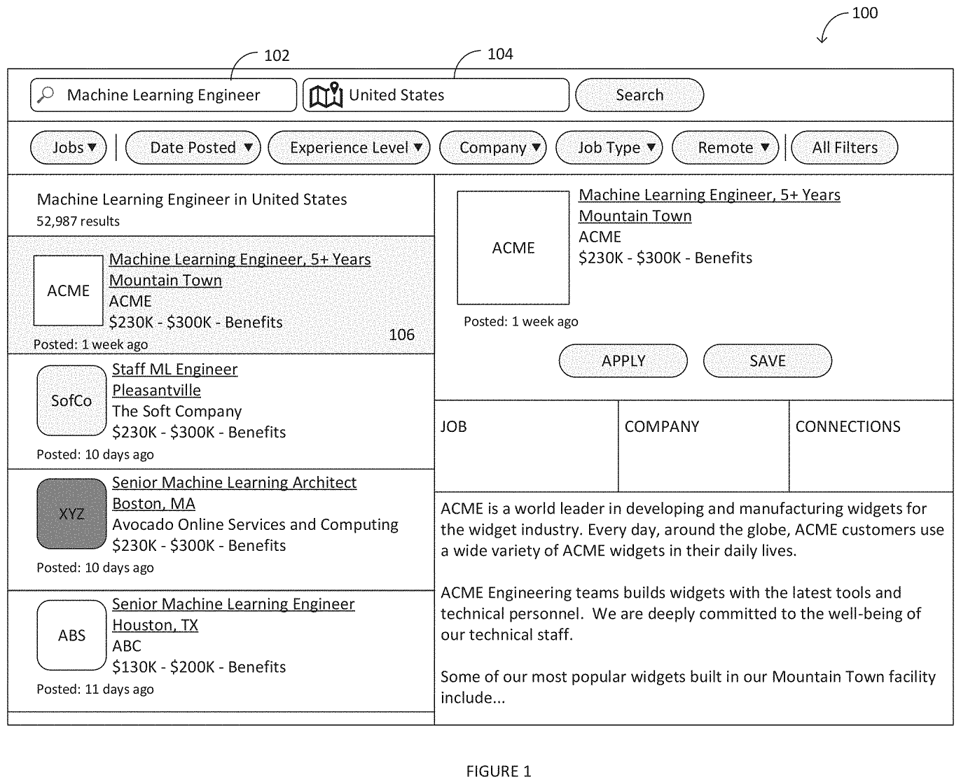

FIG. 1 is a user interface diagram illustrating a user interface 100 in which search results are presented in response to a search of online job postings, which have been ranked in accordance with an embodiment of the present invention. Consistent with some embodiments, an end-user of an online service is presented with a user interface 100, such as that illustrated in FIG. 1, allowing the end-user to specify a search query to search online job postings hosted by the online service and stored in one or more databases. As shown in FIG. 1, the user interface 100 includes a user interface element 102 prompting for text input and via which the end-user is able to enter the search query. In addition, a second user interface element 104 allows the end-user to specify a location, such that the search results will be limited to job postings that indicate available job openings in the user-specified location. In this particular example, the user interface 100 shows that the end-user has entered the search query, “machine learning engineer” via the text input user interface element 102, and expressed an interest in the location, “United States,” as shown in connection with the user interface element 104.

As illustrated in FIG. 1, the search results consist of a set of online job postings that are presented in the user interface 100 in a column on the left side, ordered from top to bottom based on their respective assigned ranking score. For instance, the first search result is a job posting 106 with job title, “Machine Learning Engineer,” offered by a company with company name, “ACME.” As will be described in greater detail below, the text that makes up the search query—in this example, “Machine Learning Engineer”—is used by the search engine to generate the ranking score for the respective job posting. In addition, the text that makes up the job title of each job posting, and the text that makes up the company name of each job posting, are both used as text inputs to Transformers when ranking a particular job posting. By way of example, in generating a ranking score for the first online job posting shown in the user interface 100, the text of the search query, “Machine Learning Engineer,” would be used as text input to a first Transformer, while the text, “Machine Learning Engineer,” of the job title would be used as a second input to a second Transformer, and the text of the company name, “ACME” would be used as a text input to a third Transformer. Each Transformer generates an encoding of its respective text input, which is then used as an input to a deep neural network to generate the ranking score for the respective online job posting.

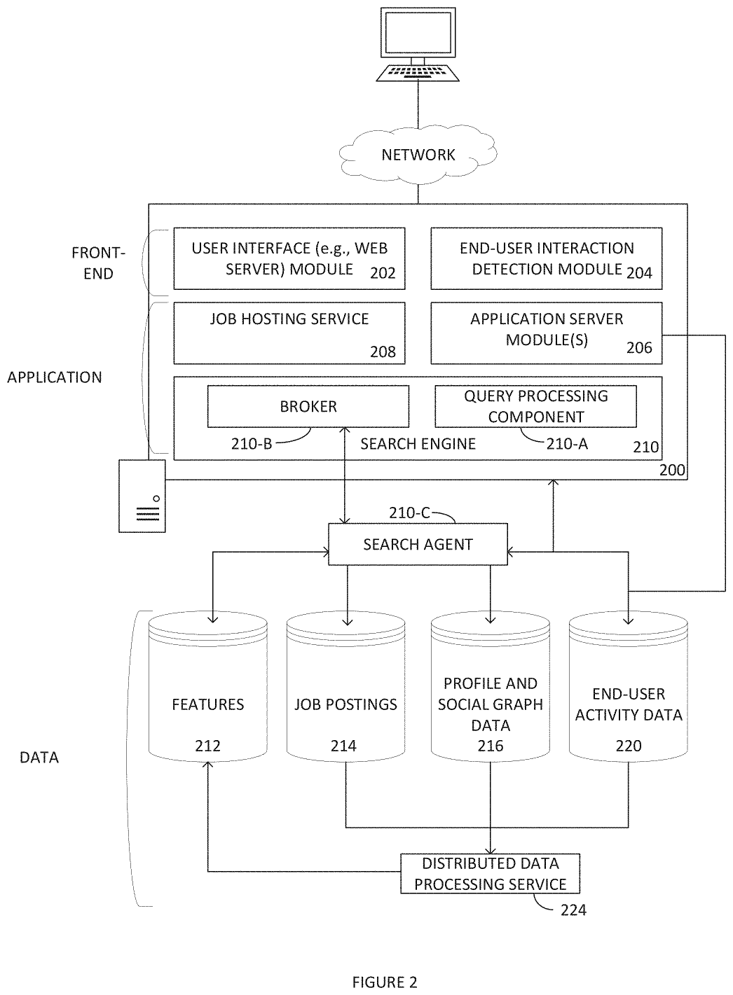

FIG. 2 is a diagram showing the functional components of a system 200 that operates an online service with which an embodiment of the invention might be implemented. As shown in FIG. 2, a front-end layer may comprise a user interface module (e.g., a web server) 202, which receives requests from various client computing devices and communicates appropriate responses to the requesting client devices. For example, the user interface module(s) 202 may receive requests in the form of Hypertext Transfer Protocol (HTTP) requests or other web-based API requests. In addition, an end-user interaction detection module 204, sometimes referred to as a click tracking service, may be provided to detect various interactions that end-users have with different applications and services, such as those included in the application logic layer of the online system. As shown in FIG. 2, upon detecting a particular interaction, the end-user interaction detection module 204 logs the interaction, including the type of interaction and any metadata relating to the interaction, in an end-user activity database 220. Accordingly, data from this database 220 can be further processed to generate data appropriate for training one or more machine-learned models, and in particular, for training models to rank online job postings.

An application logic layer may include one or more application server modules 206, which, in conjunction with the user interface module(s) 202, generate various user interfaces (e.g., web pages) with data retrieved from various data sources in a data layer. Consistent with some embodiments, individual application server modules 206 implement the functionality associated with various applications and/or services provided by the online system/service 200. For instance, the application logic layer may include a variety of applications and services to include an online job hosting service 208, via which end-users provide information about available jobs (e.g., job postings), which are stored as job postings in job postings database 214. Additionally, the application logic layer may include a search engine 210, via which end-users perform searches for online job postings. Other applications may include a job recommendation application, an online course recommendation application, and an end-user profile update service. These applications and services are provided as examples and are not meant to be an exhaustive listing of all applications and services that may be integrated with and provided as part of an online service. For example, although not shown in FIG. 2, an online system/service 200 may also include a feed, or news feed, service via which end-users are able to both post and consume content, such as news articles, and such. As end-user's interact with the various user interfaces and content items presented by these applications and services, the end-user interaction detection module 204 detects and tracks the end-user interactions, logging relevant information for subsequent use in training one or more machine learned models, such as those described in greater detail below.

As shown in FIG. 2, the data layer may include several databases, such as a profile and social graph database 216 for storing profile data, including both end-user profile data and profile data for various organizations (e.g., companies, schools, etc.). Consistent with some embodiments, when a person initially registers to become an end-user of the online service, the person will be prompted by a profile update service to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 216. Similarly, when a representative of an organization initially registers the organization with the online social networking system 200, the representative may be prompted to provide certain information about the organization. This information may be stored, for example, in the profile database 216, or another database (not shown).

Once registered, an end-user may invite other end-users, or be invited by other end-users, to connect via the online service/system 200. A “connection” may constitute a bilateral agreement by the end-users, such that both end-users acknowledge the establishment of the connection. Similarly, with some embodiments, an end-user may elect to “follow” another end-user. In contrast to establishing a connection, the concept of “following” another end-user typically is a unilateral operation and, at least with some embodiments, does not require acknowledgement or approval by the end-user that is being followed. When one end-user follows another, the end-user may receive status updates relating to the other end-user, or other content items published or shared by the other end-user user who is being followed. Similarly, when an end-user follows an organization, the end-user becomes eligible to receive status updates relating to the organization as well as content items published by, or on behalf of, the organization. For instance, content items published on behalf of an organization that an end-user is following may appear in the end-user's personalized feed, sometimes referred to as news feed. In any case, the various associations and relationships that the end-users establish with other end-users, or with other entities (e.g., companies, schools, organization) and objects (e.g., metadata hashtags (“#topic”) used to tag content items), are stored and maintained within the profile and social graph in a social graph database 216. As shown in FIG. 2, data from the profile and social graph database 216 may be processed by a distributed data processing service 224, and ultimately used as input features to one or more machine learned models—for use as training data, and/or for use in ranking job postings.

As end-users interact with the various content items that are presented via the applications and services of the online social networking system 200, the end-users' interactions and behaviors (e.g., content viewed, links or buttons selected, messages responded to, job postings viewed, job applications submitted, etc.) are tracked by the end-user interaction detection module 204, and information concerning the end-users' activities and behaviors may be logged or stored, for example, as indicated in FIG. 2 by the end-user activity and behavior database 220. Consistent with some embodiments, when an end-user submits a search query to search for job postings, the text of the search query is stored in association with any interactions that the end-user has with particular search results (e.g., job postings). As described in greater detail below, once stored, this information can be utilized as training data to train the model used in ranking job postings.

Consistent with some embodiments, data stored in the various databases of the data layer may be accessed by one or more software agents or applications executing as part of a distributed data processing service 224, which may process the data to generate derived data. The distributed data processing service 224 may be implemented using Apache Hadoop® or some other software framework for the processing of extremely large data sets. Accordingly, an end-user's profile data and any other data from the data layer may be processed (e.g., in the background or offline) by the distributed data processing service 124 to generate various derived profile data. As an example, if an end-user has provided information about various job titles that the end-user has held with the same organization or different organizations, and for how long, this profile information can be used to infer or derive an end-user profile attribute indicating the end-user's overall seniority level or seniority level within a particular organization. This derived data may be stored as part of the end-user's profile or may be written to another database.

In addition to generating derived attributes for end-users' profiles, one or more software agents or applications executing as part of the distributed data processing service 224 may ingest and process data from the data layer for the purpose of generating training data for use in training various machine-learned models, and for use in generating features for use as input to the trained models. For instance, profile data, social graph data, and end-user activity and behavior data, as stored in the databases of the data layer, may be ingested by the distributed data processing service 224 and processed to generate data properly formatted for use as training data for training any one of the machine-learned models described herein. Similarly, the data may be processed for the purpose of generating features for use as input to the machine-learned models when ranking job postings. Once the derived data and features are generated, they are stored in a database 212, where such data can easily be accessed via calls to a distributed database service. As end-users perform searches of the online job postings, and then interact with the search results, for example, by selecting various individual job postings from the search results user interface, the selections are logged by the end-user interaction detection module. Accordingly, the end-user selections, which may be referred to as click-data, can be used in training the machine learned model used in ranking job postings.

Consistent with some embodiments of the invention, the search engine 210 may be implemented to include a query processing component 210-A, a broker 210-B and one or more search agents 210-C. When the search engine 210 receives a request to process a search query for online job postings on behalf of an end-user, the query processing component 210-A processes the received search query prior to performing the actual search for online job postings. By way of example, the query processing component 210-A may enhance the search query by adding information, including additional search terms, to the query. For instance, such information may relate to one or more user profile attributes of the end-user, and/or may relate to prior activity undertaken by the end-user (e.g., past searches, previously viewed job postings, previously viewed company profiles, and so forth). Moreover, the query processing component 210-A may expand the user-provided search query by adding search terms that are synonymous with a term provided with the initial search query by the end-user. In some instances, one or more search terms provided by the end-user may be analyzed to determine whether it matches a term or phrase in a taxonomy accessible to the search engine 210. For example, in some instances, a search term may match a particular skill included in a taxonomy of skills. The query may be expanded to include similar skills, as identified by referencing the skill taxonomy, which may group or categorize skills by similarity.

Once the query processing component 210-A has concluded its operation and a final enhanced query has been generated based on the text of the initial user-provided search query, a broker 210-B will distribute the final query to one or more searchers or search agents 210-C. For example, with some embodiments, the final query is processed in parallel by a group of distributed search agents 210-C, with each search agent 210-C accessing a separate database of online job postings. Each search agent 210-C will execute the final query against its respective database of job postings to identify job postings that include text matching one or more of the search terms of the final query. Additionally, for each job posting identified by a search agent 210-C, the search agent 210-C will obtain a set of features for use as input to a deep neural network that has been trained to derive a ranking score for the respective job posting. Accordingly, each search agent 210-C will return a set of ranked online job postings to the broker 210-B, which will then merge the ranked job postings received from each search agent 210-C, and re-order the job postings by their respective ranking to create a final list of ranked job postings. Consistent with some embodiments, each search agent 210-C may return a set of ranked job postings, with the set including a number of job postings that falls within a predetermined range, such as between two-hundred and two-hundred fifty-five ranked results. Furthermore, a subset of ranked online job postings may be selected from the final list of ranked job postings for presentation to the end-user in a search results user interface. The results may be paginated, such that a predetermined number of search results are shown on each page, where the user interface provides navigation controls enabling the end-user to sequentially navigate and view more than one page of search results. Alternatively, the search results may be presented in a continuously scrolling user interface.

When the broker 210-B makes a call to the search agent(s) 210-C, each search agent 210-C has a set amount of time (e.g., two seconds) to return a set of ranked search results (e.g., job postings). The time limit set by the broker 210-B represents a default timeout value, after which the broker 210-B will continue processing the end-user request if it has not received a response from a search agent 210-C. Accordingly, if a search agent 210-A fails to respond within the time specified as the default timeout limit of the broker, the search results from the search agent 210-C will not be included in the response generated for the end-user request. The timeout value ensures that the end-user is not needlessly waiting in the rare circumstance that an error has occurred, or if no matching search results are available. As described in greater detail below, the ranking algorithm used to rank the search results is subject to certain latency requirements, such as the timeout value of the broker 210-B, and therefore is implemented to rank online job postings in a sufficiently fast manner.

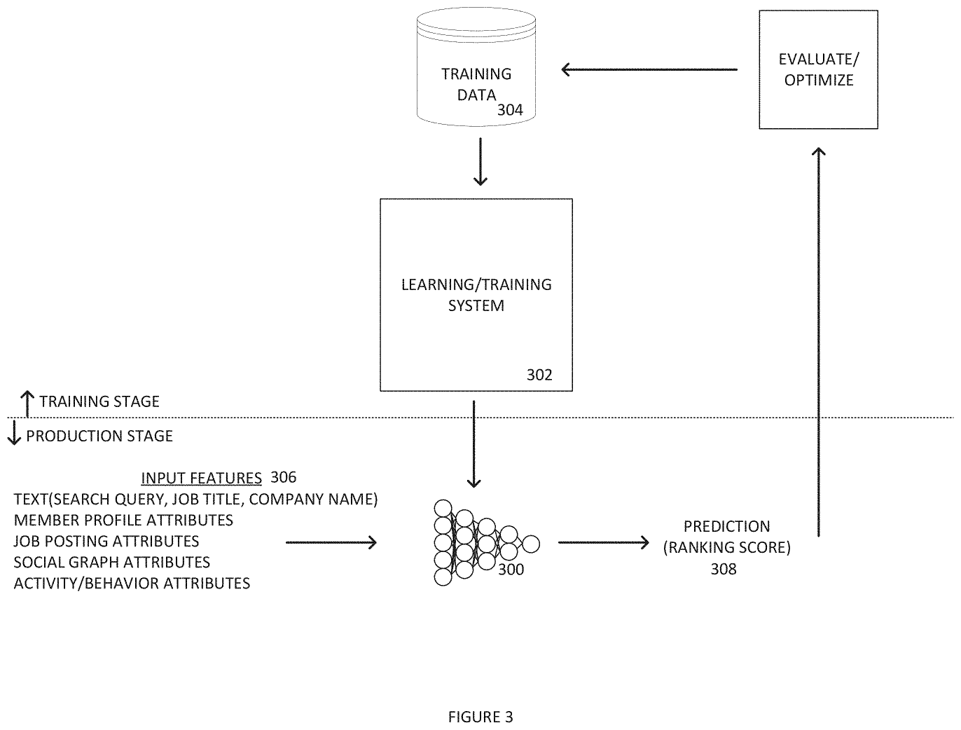

FIG. 3 is a diagram illustrating a technique by which a machine learned model is trained to rank online job postings for an online serving, production system, consistent with some embodiments. The general approach used to train the neural network model 300 for ranking job postings is a supervised learning technique frequently referred to as a learning to rank technique. As illustrated in FIG. 3, during a training stage, a learning or training system 302 is provided example inputs along with desired outputs, with the objective of learning a rule or function that will map the example inputs to the outputs. The example inputs and outputs used to train the model are generally referred to as the training data 304. A loss function is used to evaluate the performance of the model in generating the desired outputs, based on the provided inputs. Consistent with some embodiments, the loss function used in training the model 300 is a cross entropy loss function, where the Softmax function is used to normalize the final outputs of the model. During the training stage, as the training data are provided to the learning system 302, the weights of the individual neurons of the neural network model are manipulated to minimize the error, as measured by the loss function. Once fully trained and deployed in a production setting, the model 300 is provided with input features 306 similar to those used in training the model, and the model then generates a prediction (e.g., a ranking score) 308 for each instance of the set of features that correspond with a particular job posting.

Consistent with some embodiments, the supervised learning technique used to train the model 300 uses a listwise approach. Accordingly, the training data 304 used in training the model 300 is presented as an ordered set of search results derived for a particular end-user's previous search query. For example, an instance of training data will generally include among other items of information, the text of a search query provided by an end-user and used to generate an ordered set of search results (e.g., online job postings), information about the end-user (e.g., user profile data), and information relating to each of several different online job postings that were presented in a search results interface. As described in greater detail below, with some embodiments, the first layer of the neural network model 300 includes one or more Transformer encoders, which receive as input features sequences of text. The input features provided to these Transformer encoders will include at least the text of the search query provided by the end-user and from which the search results were generated, the text of the job title associated with the online job posting for which a ranking score is derived, and the text of the company name of the company associated with the job posting for which the ranking score is derived. Of course, other examples of text inputs may also be used in various embodiments.

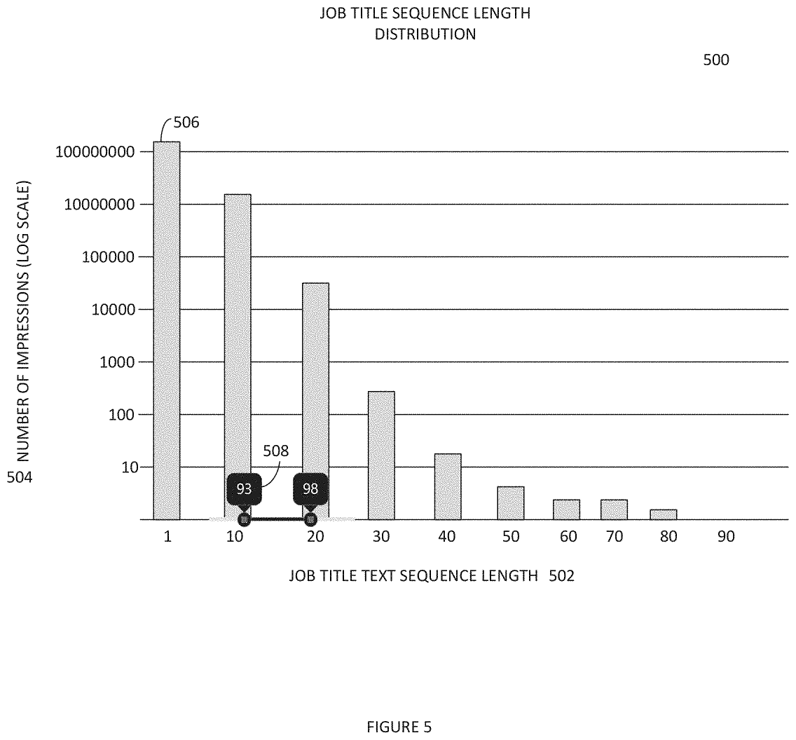

To ensure that the Transformer encoders can encode the text input sequences fast enough to satisfy the latency requirements of the ranking operation, the length of the text input sequence provided to each Transformer encoder is limited by design. As described below in connection with FIG. 5, the maximum length of the text sequence for each Transformer encoder, referred to herein as the input length threshold, is selected through a combination of initial offline analysis, followed by evaluation and testing. Consistent with some embodiments, other hyperparameters of the Transformer encoder are selected based on testing and empirical results indicating how quickly the Transformer encoder performs in conjunction with the overall deep neural network model 300 for ranking online job postings. For instance, with some embodiments, each Transformer encoder is implemented with a single layer, having ten self-attention heads, and a feed forward network dimension of four hundred. The input length threshold for search queries may be selected from a range of lengths between six to ten words, whereas the input length threshold for job titles and company names may be selected from lengths between twelve to eighteen, and eight to twelve, respectively. Of course, in various other embodiments, and with various other input text types, the input length threshold may vary.

During both training and at inference time, when the sequence of text provided as input to a Transformer encoder is less than the input length threshold for the Transformer encoder, mask padding is applied to those token positions for which there is no input text. For instance, each word or term in a sequence of terms for a search query is presumed to have a position within the sequence. By way of example, the search query, “Machine Learning Engineer” has three terms, with the term “Machine” being in the first position, the term “Learning” being in the second position, and so forth. When the length of the text input sequence is less than the input length threshold for the Transformer encoder, those input positions for which there is no corresponding text input (e.g., search term) receive a mask padding. This ensures that the Transformer encoder does not perform the self-attention operation on those input positions that do not include an actual text input. Similarly, when the length of the sequence of input text exceeds the input length threshold for a Transformer encoder, any tokens in excess of the threshold are simply discarded or ignored.

The labels for the training data are derived based on actions taken by the end-user with respect to the several job postings presented in a set of search results. For example, if an end-user selects (e.g., clicks) a particular online job posting from the search results, in order to view the job posting, this end-user activity is tracked so the end-user's action can be used to generate the labeled training data for training the ranking model 300. Consistent with some embodiments, the labeled training data may have different weights to reflect different actions taken by the end-user. For example, a selection or viewing of a job posting may be deemed a positive action, but given less weight than other end-user actions, such as saving a selected job posting for subsequent retrieval and viewing, and/or submitting an application for a job posting. Similarly, negative labels may be generated based on an end-user being presented with a job posting in the search results, but the end-user taking no action with respect to the job posting. Each end-user action may be provided a weighting factor commensurate with its perceived importance as a signal for use in ranking job postings.

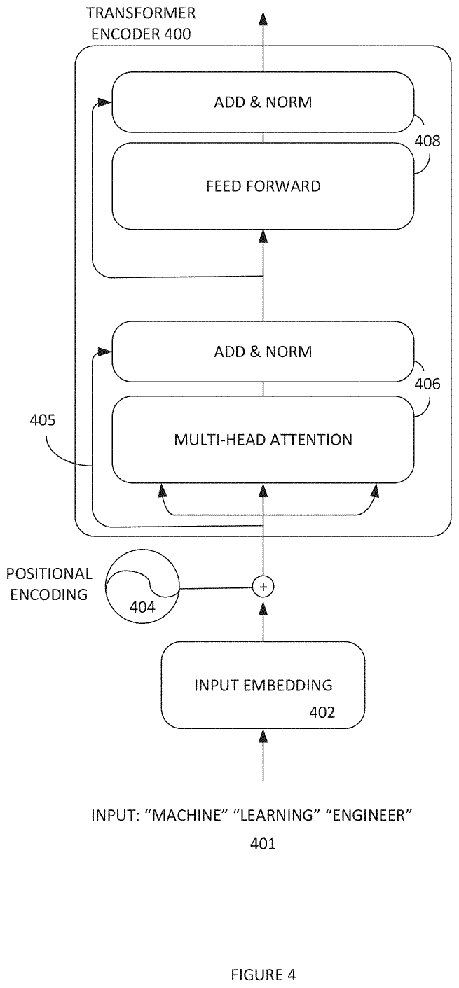

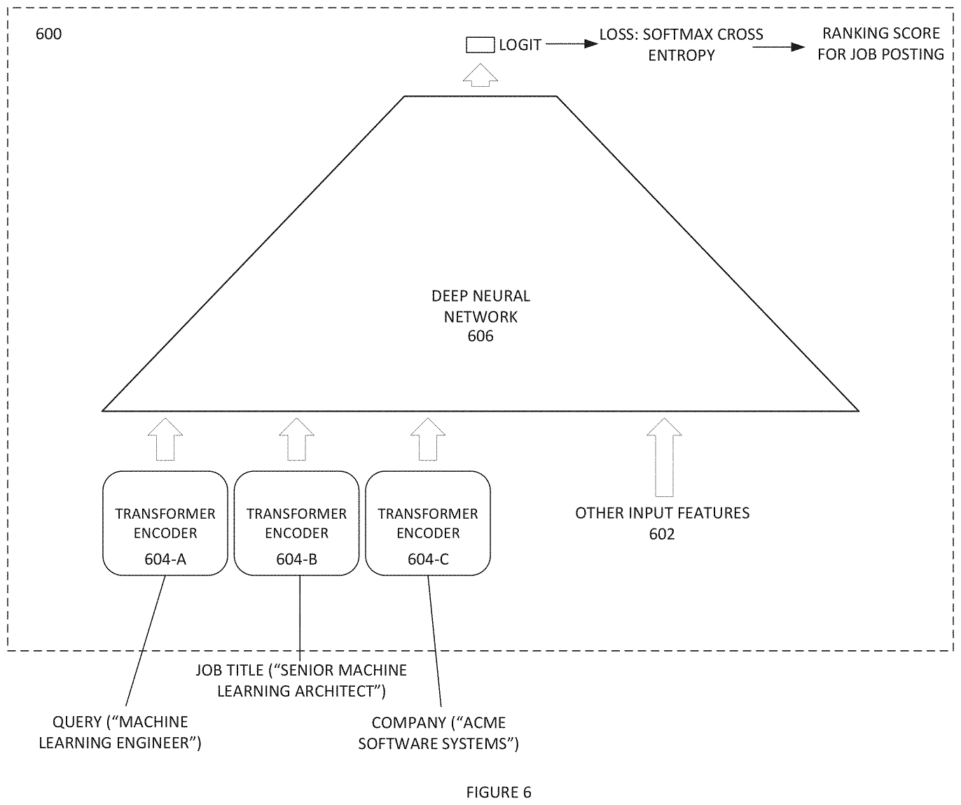

FIG. 4 is a diagram illustrating a Transformer encoder 400—a type of deep learning model—that is used to encode various sequences of text (e.g., a search query, a job title, a company name) for use as inputs to a deep neural network that is used in ranking search results (e.g., online job postings) consistent with embodiments of the invention. For example, the Transformer encoder 400 illustrated in FIG. 4 is shown as an individual element, with reference numbers 604-A, 604-B and 604-C, of the deep neural network 606 presented and described in connection with FIG. 6. Accordingly, in the neural network model 600 shown in FIG. 6, each of the individual Transformer encoders receives a text input sequence and encodes the text input sequence to generate an encoded representation that is used as an input feature to the deep neural network 606. Specifically, the Transformer encoder with reference number 604-A receives the text input representing the search query (e.g., “Machine Learning Engineer”), and generates an encoded representation of that text input for use as an input feature to the deep neural network 606. Similarly, the Transformer encoder with reference number 604-B in FIG. 6 encodes the text of a job title, and the Transformer encoder with reference number 604-C encodes the text of a company name.

Referring again to FIG. 4, an individual Transformer encoder is computationally expensive to implement as the memory requirements grow proportional to the square of the text input length. Therefore, to satisfy latency requirements for using a Transformer encoder in an online serving environment, the text input length of each input type (e.g., search query, job title, company name) is determined using offline analysis and real-world testing. Specifically, historical data for past searches are analyzed to determine an appropriate text input length for each input type. By way of example, consider the bar chart 500 shown in FIG. 5, which shows the distribution of the text sequence lengths for job titles, for each online job posting processed as part of a set of previously processed searches for job postings. In the bar chart, the X-axis 502 represents the job title text sequence length, while the Y-axis 504 represents the number of impressions (charted using a log scale)—that is, the number of occurrences of a job title of a job posting having a particular length as indicated by the respective bar in the bar chart. As is easily ascertained from the bar chart 500, the most frequently occurring text sequence length is one, as indicated by the bar in the bar chart with reference number 506. The bar chart 500 has what might be referred to as a long tail distribution, with very few job postings having job titles that exceed eighty words. Once charted, a text sequence length may be selected as a text input length threshold, based on the selected text length falling within a particular range. For example, as shown in the bar chart by the range indicator 508, text lengths from ten to twenty account for 93-98% of all occurrences. That is, for the given time period from which the historical data is associated, 93-98% of all job title text sequence lengths fell between the range of ten to twenty words in length. Accordingly, the input length threshold for a Transformer encoder that is encoding job titles may be selected to fall within the range of ten to twenty words in length, as this will ensure that the vast majority of job titles have lengths equal to or less than the selected threshold. Once the text input threshold is selected for a particular text input type, testing and evaluation may be performed to ensure that the Transformer encoder can encode job titles satisfying the text input length threshold in a timely manner that satisfies the latency requirements. This same type of analysis that is completed for establishing the text input threshold for job titles is also completed for other input types—particularly, search queries, and company names.

Referring again to FIG. 4, in operation, before the input text 401 is provided to a Transformer encoder 400, each word or token in the sequence of the input text is mapped to a pre-trained word embedding of a fixed size—that is, a vector representation of the word—using an input embedding algorithm. Consistent with some embodiments of the invention, the input embedding 402 is based on a pre-trained vocabulary of word embeddings known as GloVe (short for Global Vectors), where each word embedding is a vector of a fixed size such as one hundred. Of course, in various embodiments, the fixed size of the embedding may vary and may be twenty-five, fifty, one-hundred, two-hundred, three-hundred, or some other fixed size. Moreover, a pre-trained word vocabulary other than GloVe may be used. Consistent with some embodiments, the same vocabulary of word embeddings may be used with all Transformer encoders. However, in various alternative embodiments, two or more Transformer encoders may utilize different vocabularies of word embeddings.

When the text input length of a text input sequence exceeds the input length threshold for the Transformer encoder, the words or tokens in those positions that exceed the threshold are dropped or ignored. Similarly, when the text input length of a text input sequence is less than the input length threshold, a mask padding is applied to those input positions where there is no text input. As indicated by reference number 404, after the word embedding is completed, the vector representation of the text input is embedded with a positional encoding to indicate the position of each individual token or word in the sequence of text. This is required because the text input sequence is processed by the Transformer encoder in parallel, as opposed to sequentially, where the order of processing would indicate the position of the text input.

The Transformer encoder 400 of FIG. 4 is a single layer Transformer encoder 400, primarily consisting of two sub-layers—a multi-head self-attention pooling mechanism 406 and a position-wise feed-forward network 408. As a multi-head mechanism 406, several self-attention layers are executing in parallel. Each individual self-attention mechanism maps a query and a set of key-value pairs to an output, where the query, keys, values and outputs are all vectors. The output is computed as a weighted sum of the values, where the weight assigned to each value is computed by a compatibility function of the query with the corresponding key. As indicated by the multiple arrows pointing to the multi-head attention 406, the multi-head attention is applied individually to the inputs of the Transformer encoder. As indicated by the arrow with reference number 405, a residual connection allows for the inputs to be added to the output of the multi-head attention mechanism, and then normalized before being passed on to the position-wise feed forward network 408. Similarly, a residual connection allows the input of the feed forward network to be added to the output, and then normalized. Consistent with some embodiments, an average pooling operation is applied to the output of the feed forward network to generate a single output in the vector space, which is then routed to the next layer in the deep neural network 606.

FIG. 6 is a diagram illustrating an example of a deep neural network—a machine learned model—that is used to rank search results (e.g., online job postings), consistent with embodiments of the invention. The model 600 illustrated in FIG. 6 is consistent with a model that might be used by the search agent 210-C of the search engine 210 as illustrated in FIG. 2. As illustrated in FIG. 6, the deep neural network 606 that is used to rank the search results takes as input a variety of input features 602 and outputs a ranking score for a job posting. One of the input features is an encoded representation of the text input sequence representing the search query (e.g., the sequence of text entered by the end-user) used by the query processing module 210-A of the search engine 210 to generate the final search query. A second input feature is an encoded representation of the text input sequence representing the job title of the job associated with the job posting for which the ranking score is being derived. A third input feature is an encoded representation of a text input sequence corresponding to the company name of the company associated with the job posting for which the ranking score is being derived. The encoded representations of these sequences of text are derived using Transformer encoders 604-A, 604-B, and 604-C, which operates as described in connection with the description of FIG. 4. The other input features 602 may include a variety of information, such as information derived from various attributes of the end-user profile of the end-user who submitted the search query, information relating to actions (e.g., views, saves, submission of job applications, etc.) that the end-user has taken with respect to content (e.g., other job postings) that were presented to the end-user, information relating to other end-users with whom the end-user may be connected via a social graph of a social networking service, information relating to the job posting that is being ranked, and so forth.

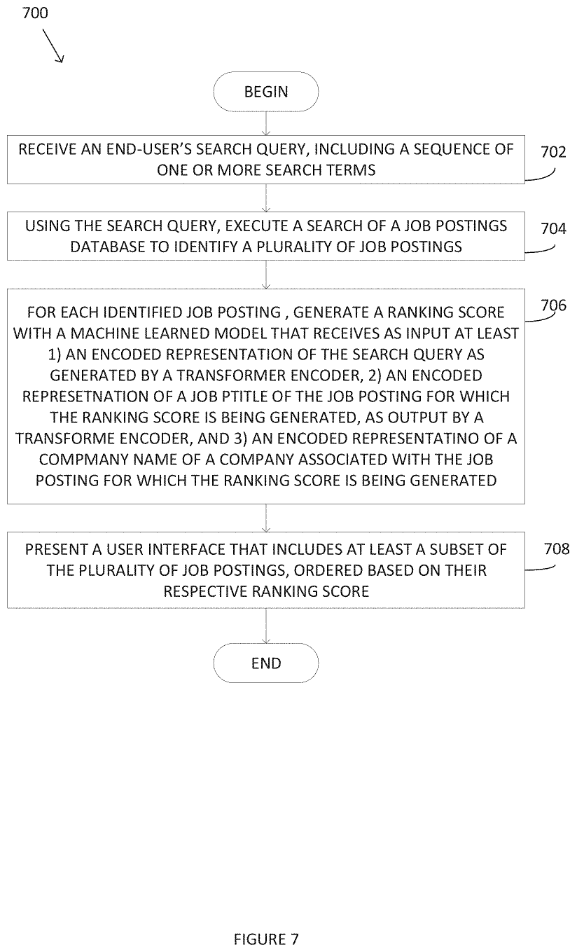

FIG. 7 is a flow diagram illustrating a computer-implemented method for processing an end-user's search query, consistent with embodiments of the invention. As illustrated in FIG. 7, the method begins at operation 702 when a search engine receives a search query, consisting of a sequence of search terms. At operation 704, the search engine utilizes the search query to identify a plurality of online job postings, stored in one or more job postings databases, which satisfy the search query. This is generally achieved using a search algorithm that attempts to match search terms of the search query with words used in the online job posting.

Next, at method operation 706, for each identified job posting, a ranking score is generated using a deep neural network—a type of machine learned model. The deep neural network is provided with a variety of input features that include at least an encoded representation of the text sequence of the search query, an encoded representation of the text sequence of the job title of the job posting that is being ranked, and an encoded representation of the text sequence of a company name for a company associated with the job posting that is being ranked. Each of the various encoded representations is derived using a Transformer encoder. The length of the text input sequence (e.g., search query, job title, company name) is first compared with an input length threshold—that is, a maximum text sequence length for each Transformer encoder—to ensure that the length of the input text sequence does not exceed the input length threshold for the particular Transformer encoder. If a particular input text sequence does exceed an input text threshold, the words in positions that exceed the maximum are simply ignored. Next, each input token (word) of the sequence of input text is mapped to a pre-trained word embedding of a fixed size (e.g., 100). Mask paddings are applied to those positions where there is no text, for example, when the length of the text input is less than the input length threshold. Positional information is then encoded with each embedding, before the word embeddings are provided to a single layer Transformer encoder that generates the final encoded representation of the input text sequence by applying an average pooling operation to the output of the Transformer encoder. The outputs of the Transformer encoders (e.g., the encoded representation of the search query, the encoded representation of the job title, and the encoded representation of the company name) are then applied as input features to the deep neural network for purposes of deriving a ranking score for a particular job posting.

Once a ranking score has been generated for each of the job postings identified by the query processing module, at method operation 708, a subset of the highest-ranking job postings is selected for presentation, and then presented, to the end-user in a search results user interface. More specifically, a server computer of the online service causes the search results user interface to be displayed at a client computing device, by generating the information that represents the user interface at the server computer and communicating the information to the client computing device.

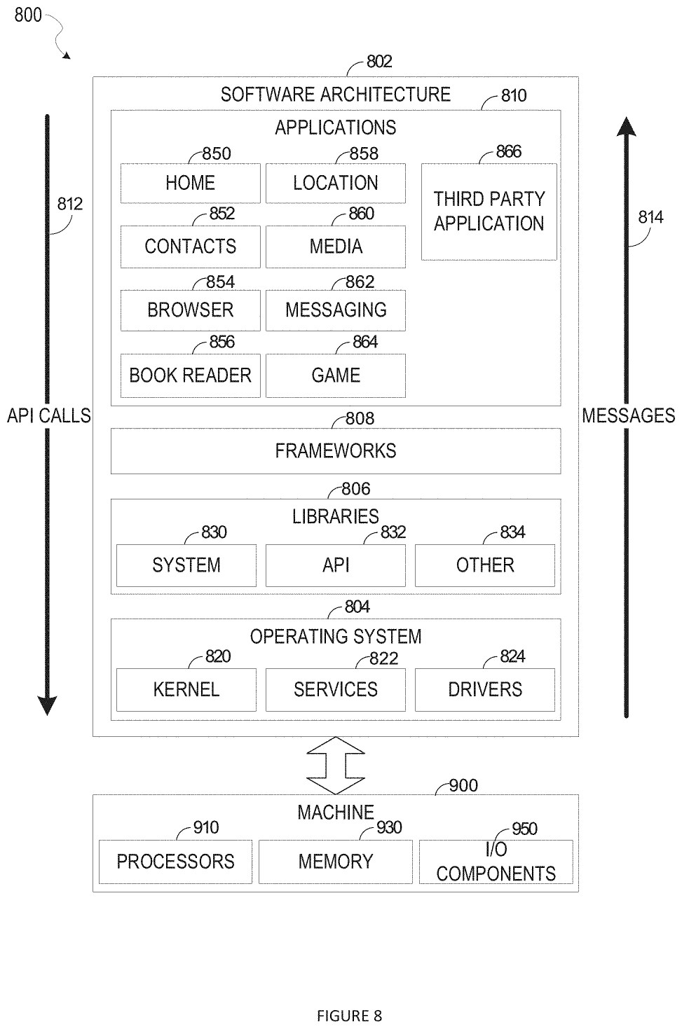

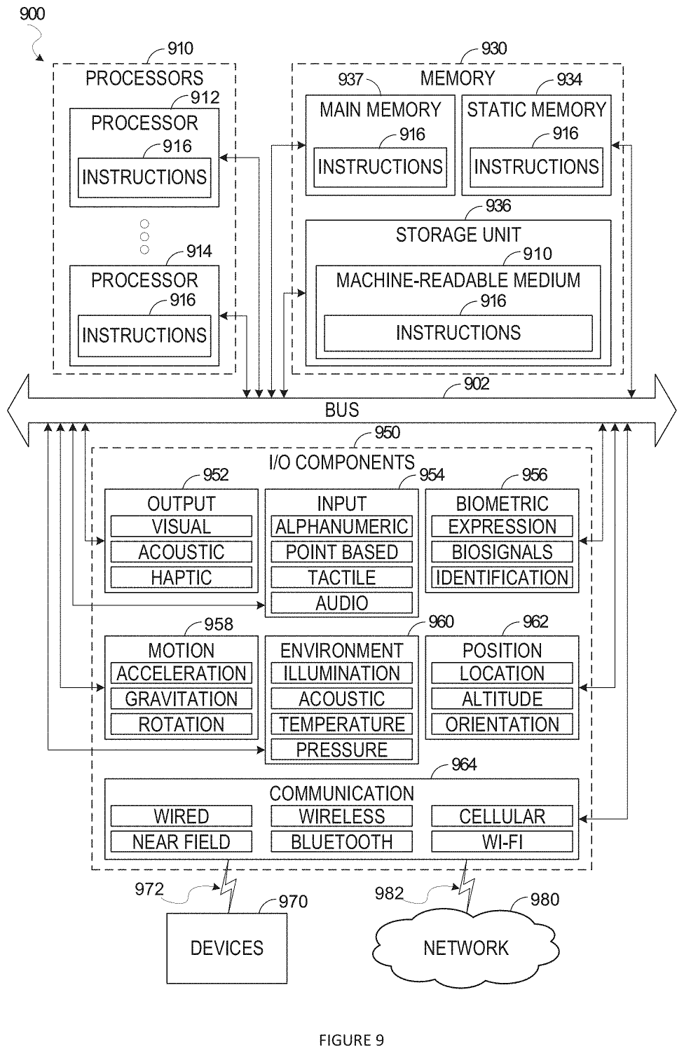

FIG. 8 is a block diagram 800 illustrating a software architecture 802, which can be installed on any of a variety of computing devices to perform methods consistent with those described herein. FIG. 8 is merely a non-limiting example of a software architecture, and it will be appreciated that many other architectures can be implemented to facilitate the functionality described herein. In various embodiments, the software architecture 802 is implemented by hardware such as a machine 900 of FIG. 9 that includes processors 910, memory 930, and input/output (I/O) components 950. In this example architecture, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers. BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 606 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC). Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 608 provide various GUI functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., software, a program, an application 910, an applet, an app, or other executable code) for causing the machine 900 to perform any one or more of the methodologies discussed herein may be executed. For example, the instructions 916 may cause the machine 900 to execute the method 700 of FIG. 7, or any other methodologies consistent with those described herein. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and 1/O components 950, which may be configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors 710 that may comprise two or more independent processors 912 (sometimes referred to as “cores”) that may execute instructions 916 contemporaneously. Although FIG. 9 shows multiple processors 910, the machine 900 may include a single processor 912 with a single core, a single processor 912 with multiple cores (e.g., a multi-core processor), multiple processors 910 with a single core, multiple processors 910 with multiple cores, or any combination thereof.

The memory 930 may include a main memory 932, a static memory 934, and a storage unit 936, all accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine 900 will depend on the type of machine 900. For example, portable machines such as mobile phones will likely include a touch input device or other such input mechanisms, while a headless server machine will likely not include such a touch input device. It will be appreciated that the I/O components 950 may include many other components that are not shown in FIG. 9. The V/O components 950 are grouped according to functionality merely for simplifying the following discussion, and the grouping is in no way limiting. In various example embodiments, the I/O components 950 may include output components 952 and input components 954. The output components 952 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like. 100481 in further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi®, components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 930, 932, 934, and/or memory of the processor(s) 910) and/or the storage unit 736 may store one or more sets of instructions 916 and data structures (e.g., software) embodying or utilized by any one or more of the methodologies or functions described herein. These instructions (e.g., the instructions 916), when executed by the processor(s) 910, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 916 and/or data. The terms shall accordingly be taken to include, but not be limited to, solid-state memories, and optical and magnetic media, including memory internal or external to the processors 910. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 980 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

1. A computer-implemented method comprising:
receiving as text a user-specified search query including a sequence of one or more search terms;
executing a search, with the search query, of a database to identify a plurality of online job postings, each online job posting having a plurality of job posting attributes relating to an available employment position, the plurality of job posting attributes including at least a job title and a company name;
for each online job posting of the plurality of online job postings, generating a ranking score by:
for each search term in the sequence of the one or more search terms that is in a position of the sequence that is less than a first input length threshold, generating a vector representation of the search term by mapping the search term to a pre-trained word embedding of a fixed size that is representative of the search term;
using a first Transformer encoder as a text encoder to generate a text encoding of the sequence of pre-trained word embeddings that corresponds with the sequence of the one or more search terms; and
providing a plurality of input features to a neural network that has been trained to output the ranking score for the online job posting, the plurality of input features including the text encoding of the sequence of pre-trained word embeddings that corresponds with the sequence of one or more search terms; and
presenting a subset of the plurality of online job postings in a user interface, ordered based on their respective ranking scores.

2. The computer-implemented method of claim 1, wherein the job title of each online job posting is a sequence of one or more words, the method further comprising:
for each online job posting of the plurality of online job postings, generating the ranking score by:
for each word in the sequence of one or more words of the job title that is in a position less than a second input length threshold, generating a vector representation of the word by mapping the word to a pre-trained word embedding of a fixed size that is representative of the word;
using a second Transformer encoder as a text encoder to generate a text encoding of the sequence of pre-trained word embeddings that corresponds with the sequence of one or more words of the job title of the online job posting; and
providing the text encoding of the sequence of pre-trained word embeddings that corresponds with the sequence of one or more words of the job title of the online job posting as an input feature to the neural network that has been trained to output the ranking score for the online job posting.

3. The computer-implemented method of claim 2, wherein the company name associated with each online job posting is a sequence of one or more words, the method further comprising:
for each online job posting of the plurality of online job postings, generating the ranking score by:
for each word in the sequence of one or more words of the company name that is in a position less than a third input length threshold, generating a vector representation of the word by mapping the word to a pre-trained word embedding of a fixed size that is representative of the word;
using a third Transformer encoder as a text encoder to generate a text encoding of the sequence of pre-trained word embeddings that corresponds with the sequence of one or more words of the company name; and
providing the text encoding of the sequence of pre-trained word embeddings that corresponds with the sequence of one or more words of the company name of the online job posting as an input feature to the neural network that has been trained to output the ranking score for the online job posting.

4. The computer-implemented method of claim 1, further comprising:
prior to generating a text encoding of the search query by the first Transformer encoder, applying a mask padding to those input positions of inputs to the first Transformer encoder for which there is no corresponding search term.

5. The computer-implemented method of claim 3, wherein the text encoding of the search query, the text encoding of the job title, and the text encoding of the company name are based on a common vocabulary of pre-trained word embeddings.

6. The computer-implemented method of claim 5, wherein the first Transformer encoder, the second Transformer encoder and the third Transformer encoder are each single layer Transformer encoders.

7. The computer-implemented method of claim 5, wherein the first Transformer encoder, the second Transformer encoder and the third Transformer encoder each have a first sub-layer comprising a multi-head self-attention network with a plurality of heads.

8. The computer-implemented method of claim 7, wherein the first Transformer encoder, the second Transformer encoder and the third Transformer encoder each have a second sub-layer with a feed forward network with a dimension size that is a multiple of the fixed size of the word embeddings.

9. The computer-implemented method of claim 3, wherein the fixed size of the pre-trained word embeddings is one of: 25, 100, 200, or 300.

10. The computer-implemented method of claim 1, wherein using the first Transformer encoder as a text encoder to generate a text encoding of the sequence of pre-trained word embeddings that corresponds with the sequence of the one or more search terms involves applying an average pooling operation to text encodings of the individual search terms to derive the text encoding of the sequence of pre-trained word embeddings that corresponds with the sequence of one or more search terms of the search query.

11. A system comprising:
at least one processor;
a computer-readable storage medium storing instructions thereon, which, when executed by the at least one processor, cause the system to:
receive as text a user-specified search query including a sequence of one or more search terms;
execute a search, with the search query, of a database to identify a plurality of online job postings, each online job posting having a plurality of job posting attributes relating to an available employment position, the plurality of job posting attributes including at least a job title and a company name;
for each online job posting of the plurality of online job postings, generate a ranking score by:
with a first Transformer encoder, generating a text encoding of the sequence of one or more search terms;
with a second Transformer encoder, generating a text encoding of a sequence of words representing a job title associated with the online job posting;
with a third Transformer encoder, generating a text encoding of a sequence of words representing a company name of a company associated with the online job posting;
deriving the ranking score with a neural network that has been trained to output the ranking score for the online job posting using a plurality of input features, the plurality of input features including at least the text encoding of the sequence of one or more search terms, the text encoding of the sequence of words representing the job title, and the text encoding of the company name; and
present one or more of the plurality of online job postings in a user interface, ordered based on their respective ranking scores.

12. The system of claim 11, wherein text inputs provided to each of the first Transformer encoder, the second Transformer encoder and the third Transformer encoder are mapped to pre-trained word embeddings of a fixed size using a common vocabulary of pre-trained word embeddings for each Transformer encoder.

13. The computer-implemented method of claim 12, wherein the fixed size of the pre-trained word embeddings is one of: 25, 100, 200, or 300.

14. The system of claim 11, wherein, prior to generating a text encoding of the search query by the first Transformer encoder, a mask padding is applied to those input positions of inputs to the first Transformer encoder for which there is no corresponding search term.

15. The system of claim 11, wherein the first Transformer encoder, the second Transformer encoder and the third Transformer encoder are each single layer Transformer encoders.

16. The system of claim 11, wherein the first Transformer encoder, the second Transformer encoder and the third Transformer encoder each have a first sub-layer comprising a multi-head self-attention network with a plurality of heads.

17. The system of claim 11, wherein the first Transformer encoder, the second Transformer encoder and the third Transformer encoder each have a second sub-layer with a feed forward network with a dimension size that is a multiple of the fixed size of the word embeddings.

18. The system of claim 11, wherein, when generating a text encoding, each of the first Transformer encoder, the second Transformer encoder, and the third Transformer encoder, generates the text encoding by applying an average pooling operation to text encodings of individual search terms to derive the text encoding of the sequence of pre-trained word embeddings that corresponds with the sequence of one or more search terms of the search query.

19. A system comprising:
at least one processor;
a computer-readable storage medium storing instructions thereon, which, when executed by the at least one processor, cause the system to:
train a neural network to output a ranking score for an online job posting based on a set of input features, wherein the neural network is trained using a listwise training algorithm with training data derived from historical information from prior searches, the neural network having a plurality of Transformer encoders to encode instances of input text sequences including at least a first input text sequence representing a search query entered by an end-user, a second text input sequence representing a job title associated with a job posting, and a third text input sequence representing a company name of a company associated with the job posting;
receiving a search query from an end-user;
processing the search query of the end-user by:
identifying a set of online job postings satisfying the search query; and
for each identified online job posting, generating a ranking score with the neural network by providing as input features to the neural network at least a first text input sequence representing the end-user search query, a second text input sequence representing a job title of the job posting, and a third text input sequence representing a company name of a company associated with the job posting; and
presenting a user interface with a subset of ranked online job postings, ordered by the respective ranking scores of the online job postings.

20. The system of claim 19, wherein text input sequences provided to each Transformer encoder of the plurality of Transformer encoders are mapped to pre-trained word embeddings of a fixed size using a common vocabulary of pre-trained word embeddings for each Transformer encoder.
